(19) United States
(12) Patent Application Publication
(10) Pub. No.: US 2026/0326640 A1
(43) Pub. Date: Oct. 22, 2026

(54) ADJUSTABLE HEADREST

(71) Applicant: MFI ITALY ENGINEERING S.R.L., Milano (MI) (IT)

(72) Inventors: Bruno ZAMBON, Grugliasco (TO) (IT); Aldo CASSIANI, Grugliasco (TO) (IT)

(21) Appl. No.: 19/109,484

(22) PCT Filed: Aug. 29, 2023
(86) PCT No.: PCT/IB2023/058517

§ 371 Date: Mar. 6, 2025

(30) Foreign Application Priority Data
Sep. 7, 2022 (IT) 102022000018264

(51) Int. Cl. B60N 2/818; B60N 2/815; B60N 2/865

(52) U.S. Cl. CPC B60N 2/818; B60N 2/815; B60N 2/865

(57) ABSTRACT

A headrest is provided that is adjustable. The headrest is adjustable according to two different directions substantially perpendicular to each other and comprises one or more supporting rods and a headrest body that is adjustable on the supporting rods along a first direction and in turn comprises a front shell and a rear shell. The position of the shells relative to each other being adjustable along a second direction substantially orthogonal to the first direction. The headrest comprises a single control slider acting directly both onto locking elements to allow/prevent adjustment along the first direction and, simultaneously, onto first and/or second engagement elements to allow/prevent adjustment along the second direction.

### TECHNICAL FIELD

The present invention relates to an adjustable headrest, and particularly to a headrest whose position can be adjusted according to two different directions that are substantially perpendicular to each other.

The present invention finds application particularly, though not exclusively, in the manufacturing of headrests for vehicle seats.

### BACKGROUND ART

Headrests, in particular headrests for vehicle seats, adjustable along two directions substantially perpendicular to each other (also called “4-way” or “4W” headrests) are known from prior art,

In particular, said headrests comprise a headrest body whose position can be adjusted in the vertical direction, i.e., towards or away from the upper side of the seat backrest, so as to adjust the position of said headrest body according to the height of the user occupying the seat.

The position of the headrest body (or at least part thereof) is also adjustable in a horizontal direction substantially perpendicular to the plane in which the seat backrest lies, so as to bring said headrest body (or at least said part thereof) close to or move it away from the head of the user occupying the seat.

According to some solutions of known type, adjustment in the vertical direction and adjustment in the horizontal direction are implemented by separate and independent mechanisms and are carried out separately from each other.

According to other solutions of known type, adjustment in the vertical direction and adjustment in the horizontal direction are carried out simultaneously.

In these latter solutions, the headrest is provided with a single control element: when said control element is in the rest position, the headrest body is locked and any movement of said headrest body both in the vertical direction and in the horizontal direction is prevented; when the user acts on said control element to bring it from the rest position to a working position, the headrest body is unlocked and is movable both in the vertical direction and in the horizontal direction, so that adjustment in both directions can be carried out simultaneously. When the user releases the control element, this returns to the rest position and the headrest body is locked in the new selected configuration.

See by way of example the adjustable headrests described in documents EP 3 153 347 and US 2015/0203008, as well as the adjustable headrests described in documents DE 102010062575 and WO 2019/238516.

These latter two documents, particularly, disclose a single control element, defined as a control button, which, when pushed, actuates a series of mechanisms. These mechanisms in turn unlock the movement of the headrest body with respect to both the vertical direction and the horizontal direction, thereby allowing adjustment of the headrest body in both directions.

In addition, solutions are known in which the headrest body is adjusted by means of electric motors: a first motor, when operated, allows movement of the headrest body in the vertical direction, and a second motor, when operated, allows movement of the headrest body in the horizontal direction.

This type of solution is described, for example, in document CN 113 415 222.

Adjustable headrests of known type, however, are not free of drawbacks.

In general, the adjustment mechanisms of such headrests are complex and involve a large number of components, which leads to several disadvantages.

Firstly, the presence of a large number of components makes the kinematic chain between the control element and the regulating elements complex, and therefore scarcely efficient in terms of achieving precise and effective motion transmission.

Besides, a complex kinematic chain also imposes strict constraints in terms of machining tolerances on the various components thereof to ensure the correct transmission of motion, which leads to higher production costs.

Secondly, a large number of components generally implies higher production times and costs, more complex assembly operations and higher risks of assembly errors.

Furthermore, a complex adjustment system with a large number of components requires a considerable amount of space, which in turn leads to limitations in terms of headrest design, as well as the risk of poor user comfort.

A last, though not negligible, drawback is that a large number of components also affects the overall weight of the headrest, which is generally considered a negative factor by vehicle manufacturers.

The main object of the present invention is therefore to overcome the above-mentioned drawbacks of prior art by providing an adjustable headrest whose adjustment system is simple, robust and reliable.

This and other objects are achieved with a headrest as claimed in the appended claims.

### SUMMARY OF INVENTION

The invention relates to a headrest comprising one or more supporting rods and a headrest body mounted on said support rods, said headrest body in turn comprising a headrest body front portion or front shell and a headrest body rear portion or rear shell.

Said supporting rods are arranged to be attached to the backrest of a seat and the position of said headrest body along said supporting rods is adjustable, i.e., the position of the headrest body is adjustable in a first direction or vertical direction to bring it close to or move it away from the upper side of the seat backrest.

In addition, the position of the front shell of the headrest body relative to the rear shell of the headrest body is adjustable in a second direction or longitudinal direction, substantially perpendicular to said first direction, so that the front shell of the headrest body can be brought close to or moved away from a user's head.

For this purpose, the headrest body is provided with one or more locking elements (one for each supporting rod), each of which is controllable for switching from a locking position, in which it interacts with a respective supporting rod and locks the position of the headrest body relative thereto, to an unlocking position, in which it does not interact with the respective supporting rod and allows varying the position of the headrest body relative thereto, and vice versa.

The headrest body is further provided with first engaging elements integral with the front shell, as well as with second engaging elements integral with the rear shell, said first engaging elements and/or said second engaging elements being controllable for switching from an engagement position, in which they mutually interact and lock the position of the front shell relative to the rear shell, to a disengagement position, in which they do not mutually interact and allow varying the position of the front shell relative to the rear shell, and vice versa.

According to the invention, the headrest comprises a single control slider acting directly both onto said locking elements in order to bring them from the locking position to the unlocking position and vice versa, and onto said first and/or second engaging elements in order to bring them from the engagement position to the disengagement position and vice versa.

The control slider usually is in an inactive position, in which the locking elements are in the locking position, the first and second engaging elements are in the engagement position and the configuration of the headrest body is locked. For this purpose, the headrest may comprise elastic means for urging the control slider towards said inactive position.

The headrest according to the invention further comprises a control element, such as, for example, a control button, onto which the user can act to bring the control slider to an active position (by overcoming the resistance of the elastic means, where provided), wherein the control slider controls switching of the locking elements to the unlocking position and switching of the first and/or second engaging elements to the disengagement position, whereby the configuration of the headrest body can be varied.

According to a preferred and particularly simple embodiment of the invention, the locking elements are directly and rigidly connected to the control slider; in addition, the first and/or second engaging elements are directly and rigidly connected to the control slider.

It will be apparent to the person skilled in the art that in this way the kinematic chain of the headrest adjustment system according to the invention is extremely simple and compact, which makes the construction and assembly of said adjustment system simple and inexpensive and operation thereof extremely reliable.

Furthermore, construction and assembly are made particularly easy by the absence of small metal parts and, in general, the extremely limited number of small components.

For the same reasons, the headrest adjustment system according to the invention is robust and has a high resistance to wear and tear and deformation due to stress during adjustment and operation in general.

Finally, the structure of the headrest adjustment system according to the invention allows for greater precision during adjustments, especially along the second or longitudinal direction.

According to a preferred embodiment of the invention, in order to switch from said inactive position to said active position the control slider moves along a third direction or transverse direction, substantially perpendicular both to the first direction and the second direction (i.e., substantially perpendicular to both adjustment directions).

### BRIEF DESCRIPTION OF DRAWINGS

Further features and advantages of the present invention will become more evident from the ensuing detailed description of some preferred embodiments of the invention, given by way of non-limiting examples with reference to the annexed drawings, in which:

FIG. 1 is an exploded perspective view of the headrest according to the invention.

FIG. 2 shows the main components of the adjustment system along the first direction of vertical direction of the headrest of FIG. 1;

FIG. 3a shows the locking elements of the adjustment system of the headrest of FIG. 1 in the locking position;

FIG. 3b shows the locking elements of the adjustment system of the headrest of FIG. 1 in the unlocking position;

FIG. 4 shows the main components of the adjustment system along the second direction or longitudinal direction of the headrest of FIG. 1;

FIG. 5a shows the first and second engaging elements of the adjustment system of the headrest of FIG. 1 in the engagement position;

FIG. 5b shows the first and second engaging elements of the adjustment system of the headrest of FIG. 1 in the disengagement position.

### DESCRIPTION OF EMBODIMENTS

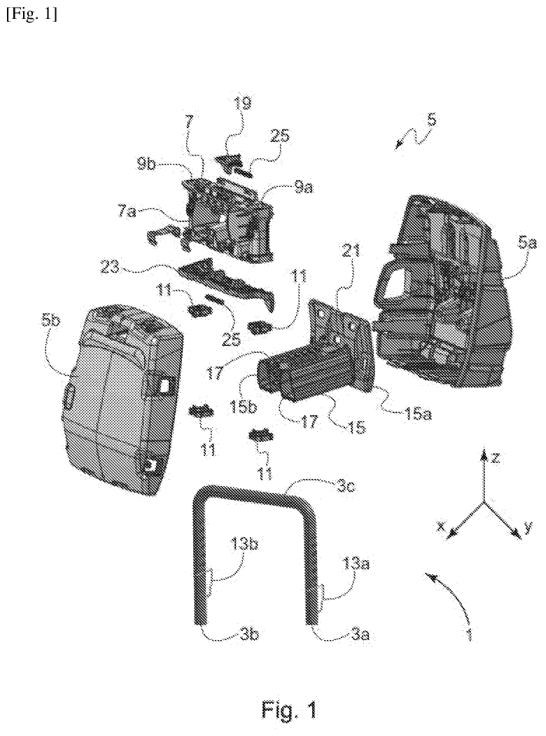

Referring at first to FIG. 1, this shows a headrest 1 according to the invention.

The headrest 1 may be, for example, a headrest of vehicle seats, especially motor vehicle seats. However, this application should not be considered in a limiting sense and the headrest 1 can also be applied to other types of seats.

The headrest 1 comprises one or more supporting rods. In particular, in the embodiment of FIG. 1, the headrest 1 comprises two supporting rods 3a, 3b. However, it would also be possible to provide a different number of support rods.

Said supporting rods 3a, 3b are arranged to be attached, at their first ends or lower ends, to the backrest of a seat and, in the shown embodiment, they are connected to each other by means of a transverse member 3c at their second ends or upper ends.

The headrest 1 further comprises a headrest body—indicated as a whole with reference numeral 5—mounted on the supporting rods 3a, 3b.

For this purpose, the headrest body 5 comprises an inner frame 7 provided with seats or channels 9a, 9b inside which the supporting rods 3a, 3b are respectively housed.

As will be evident from the description below, the inner frame 7—and thus the headrest body 5—is mounted on the supporting rods 3a, 3b in such a way as to be slidable along said rods, whereby the position of the headrest body is adjustable in a first direction or vertical direction Z.

Correspondingly, guide bushings 11 are preferably provided along the channels 9a, 9b of the inner frame 7. For instance, in the shown embodiment, each channel 9a, 9b of the inner frame 7 is provided with a first guide bushing 11 at its lower end and with a second guide bushing 11 at its upper end.

To selectively allow or prevent sliding of the headrest body 5 relative to the supporting rods 3a, 3b, the headrest 1 is provided with locking elements 13a, 13b (one for each supporting rod 3a, 3b), whose structure and operation will be described in detail below.

The headrest body 5 further comprises a headrest body front shell or front portion 5a and a headrest body rear shell or rear portion 5b.

As will be evident from the description below, the front shell 5a and the rear shell 5b are connected to each other so that their distance along a second direction or longitudinal direction X (substantially perpendicular to said first direction or vertical direction Z) can be varied.

Correspondingly, one of said shells—specifically the rear shell 5b—is directly and fixedly connected to the inner frame 7, whereas the other one of said shells—specifically the front shell 5a—is connected to a slide 15, which comprises for this purpose a connecting plate 15a and is provided with a body 15b which is slidably received in a corresponding seat 7a provided in the inner frame 7.

The body 15b of the slide 15 and the seat 7a of the inner frame 7 can be shaped in such a way as to ensure that alignment between said slide 15 and said inner frame 7 is maintained when the slide slides relative to the inner frame, i.e., movement of the slide 15 relative to the inner frame 7 (and thus movement of the front shell 5a relative to the rear shell 5b) takes place solely along the second direction or longitudinal direction X.

For example, in the shown embodiment, the body 15b of the slide 15 is provided with four ribs 17 oriented along said second direction or longitudinal direction X, which are received in corresponding grooves (these, too, being oriented along said second direction or longitudinal direction X) provided along the inner profile of the seat 15 of the inner frame 7.

It is evident that the ribs could also be provided in different numbers on the body 15b of the slide 15, and it is also evident that it would be possible to provide grooves oriented along said second direction or longitudinal direction X on the body 15b of the slide 15 and corresponding ribs (these, too, being oriented along said second direction or longitudinal direction X) along the profile of the seat 7a of the inner frame 7.

To selectively allow or prevent sliding of the slide 15 relative to the inner frame 7, said inner frame is provided with first engaging elements 19 and the slide 15 is provided with second engaging elements 21, whose structure and operation will be described in detail below.

According to the invention, the locking elements 13a, 13b are controllable for switching from a locking position, in which they lock the position of the inner frame 7 (and thus of the headrest body 5) relative to the respective supporting rods 3a, 3b, to an unlocking position, in which they do not interact with the respective supporting rods and leave the inner frame 7 free to slide relative thereto.

In addition, the engaging elements 19, 21 are controllable for switching from an engagement position, in which they interact with each other and lock the position of the slide 15 relative to the inner frame 7 (and therefore the position of the front shell 5a relative to the rear shell 5b), to a disengagement position, in which they do not interact with each other and allow sliding of the slide 15 relative to the inner frame 7 (and therefore variation of the distance between the front shell 5a and the rear shell 5b).

According to the invention, the headrest 1 provides for a single control slider 23 which simultaneously controls switching of said locking elements 13a, 13b from said locking position to said unlocking position and switching of said engaging elements 19, 21 from said engagement position to said disengagement position, and vice versa.

Particularly, according to the invention the control slider 23 acts directly onto said locking elements 13a, 13b to control switching thereof from said locking position to said unlocking position and vice versa, and it acts directly onto said first engaging elements 19 or said second engaging elements 21 to control switching thereof from said engagement position to said disengagement position and vice versa.

Even more particularly, in the shown embodiment, said locking elements 13a, 13b are directly and rigidly connected to said control slider 23 and said first engaging elements 19 are directly and rigidly connected to said control slider 23 (in an alternative embodiment, the second engaging elements 21 could be directly connected thereto).

Preferably, the control slider 23 is movable along a third direction or transverse direction Y to simultaneously control switching of said locking elements 13a, 13b from said locking position to said unlocking position and switching of said engaging elements 19, 21 from said engagement position to said disengagement position, and vice versa, said third direction or transverse direction Y being substantially orthogonal both to the first direction or vertical direction Z and the second direction or longitudinal direction X.

It is obvious that during normal use the configuration of the headrest body must be fixed. For this reason, the control slider 23 is normally in an inactive position, in which said locking elements 13a, 13b are in the locking position and said engaging elements 19, 21 are in the engagement position.

Preferably, elastic means, such as springs 25, urges the control slider 23 towards said inactive position.

From said inactive position, by overcoming the resistance of the springs 25, the control slider 23 can be brought—by translating along said third direction or transverse direction Y—to an active position in which it controls switching of said locking elements 13a, 13b to the unlocking position and switching of said engaging elements 19, 21 to the disengagement position.

For example, it is possible to provide a control element, such as a control button (not shown in FIG. 1), onto which the user can act to bring the control slider 23 from its inactive position to the active position.

Once the user releases the control element (button), the springs 25 bring the control slider 23 back to the inactive position.

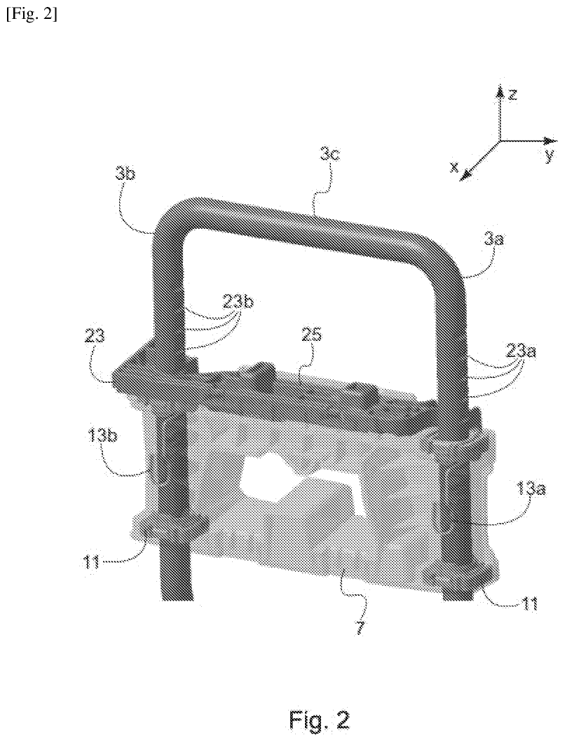

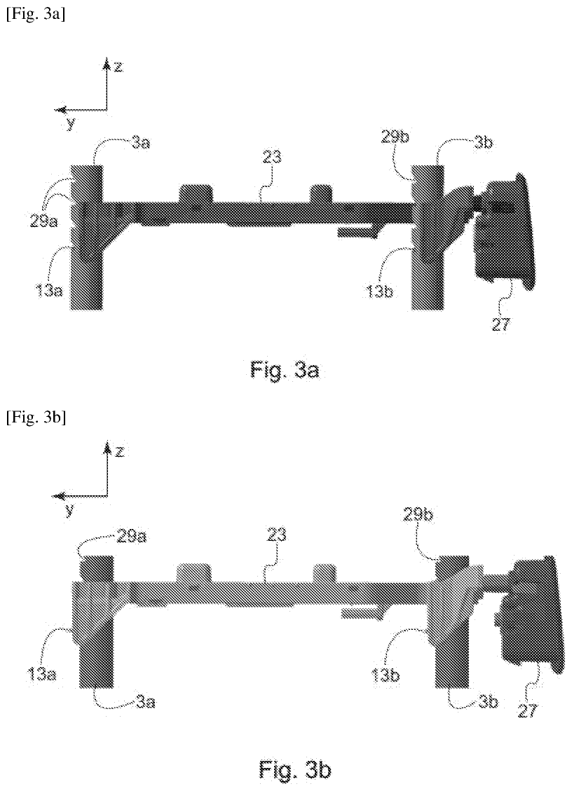

FIGS. 2, 3a and 3b shows in greater detail the mechanism of adjustment in the first direction or vertical direction Z. As anticipated above, only the components of the headrest 1 that are necessary for understanding said adjustment mechanism are illustrated in said figures.

In the shown embodiment, two locking elements 13a, 13b are provided, one for each of the supporting rods 3a, 3b.

In the shown embodiment, said locking elements 13a, 13b are made as suitably shaped wire elements and are directly and rigidly connected to the body of the control slider 23.

In the locking position—shown in FIG. 3a—said locking elements 13a, 13b are in contact with the surface of the respective supporting rod.

To ensure firm and secure locking of the locking elements 13a, 13b when they are in this position, notches 29a, 29b suitable for firmly accommodating said locking elements are provided on the body of each of the supporting rods 3a, 3b.

The notches 29a, 29b are distributed, preferably uniformly, on the surface of the supporting rods 3a, 3b along the first direction or vertical direction Z.

Preferably, said notches are provided with a pilot surface. In this way, if at the end of the operation of adjusting the position of the headrest body the locking elements are in an intermediate position between two adjacent notches, said locking elements will be smoothly accompanied towards the nearer notch, and will be firmly accommodated therein.

In FIG. 3b, the locking elements are shown in the unlocking position. The user has acted onto the control button 27, by overcoming the resistance of the springs 25 and causing translation of the control slider 23 along the third direction or transverse direction Y. As the locking elements are directly and rigidly connected to the body of said control slider, they too have performed a translational movement along the third direction or transverse direction Y (leftwards in the Figures), thus getting out of the notches 29a, 29b and moving away from the surface of the respective supporting rods 3a, 3b.

In this configuration, the inner frame 7 (and thus the headrest body 5) can slide along the supporting rods 3a, 3b in the first direction or vertical direction Z.

Upon release of the control button 27, the spring 25 will bring the control slider 23 back to the starting position, and therewith the locking elements 13a, 13b will be brought again to the locking position.

As can be seen by comparing FIGS. 3a and 3b, owing to the fact that the control slider 23 performs a simple translational movement in the transverse direction Y, that the locking elements are directly and rigidly connected to the body of said control slider, and that the supporting rods 3a, 3b are provided, on their faces oriented along said transverse direction Y, with the notches 29, 29b, the kinematic chain is compact and consists of a very small number of components, and adjustment of the position of the headrest along the first direction or vertical direction Z is simple and reliable.

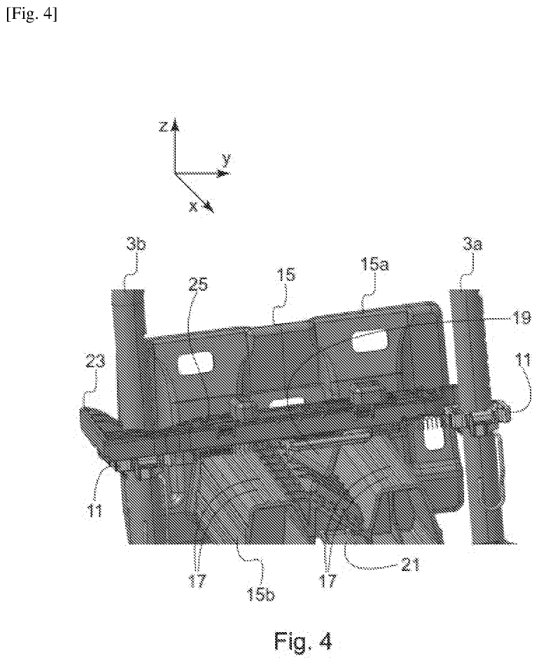

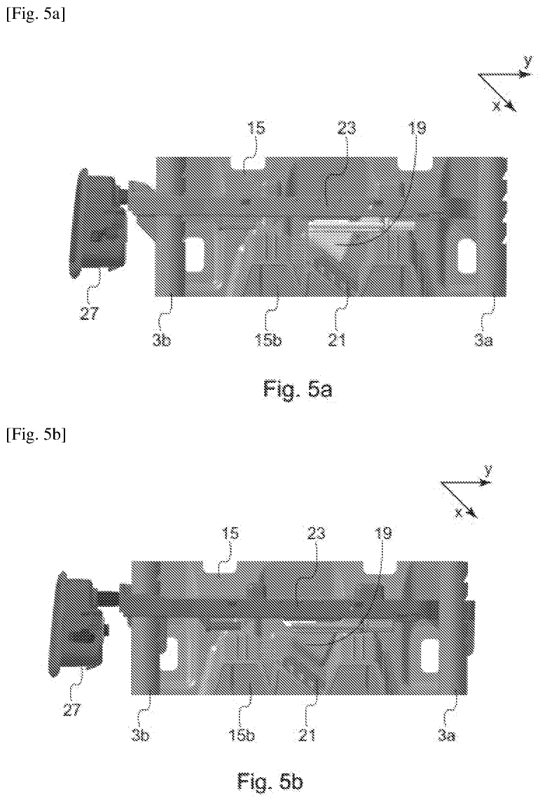

FIGS. 4, 5a and 5b show in more detail the mechanism of adjustment in the second direction or longitudinal direction X. As anticipated above, only the components of the headrest 1 that are necessary for understanding said adjustment mechanism are illustrated in said figures.

In the shown embodiment, the first engaging elements are made as an engaging tooth 19, which is directly and rigidly connected to the body of the control slider 23.

The second engaging elements 21 are made as a rack profile 21 provided on the body 15b of the slide 15, wherein the engaging tooth 19 and the rack profile 21 are suitably shaped and arranged so that the engaging tooth 19 can fit into the seats of the rack profile 21.

In the engagement position—shown in FIG. 5a—the engaging tooth 19 is indeed inserted in a seat of the rack profile 21 and it is firmly held therein by virtue of the thrust exerted by the springs 25.

In FIG. 5b, the first and second engaging elements are shown in the disengagement position. The user has acted on the control button 27, by overcoming the resistance of the springs 25 and causing translation of the control slide 23 along the third direction or transverse direction Y. The engaging tooth 19, being directly and rigidly connected to the body of said control slider, has also performed a translational movement along the third direction or transverse direction Y (rightwards in the Figures), thus getting out of the seat in which it was received and moving away from the rack profile 21.

In this configuration, the slide 15 (and thus the front shell 5a of the headrest 5) can slide relative to the inner frame 7 (and thus to the rear shell 5a of the headrest body 5) in the second direction or longitudinal direction X.

Upon release of the control button 27, the springs 25 will bring the control slider 23 back to the starting position, and therewith the engagement tooth 19 will be brought again into engagement with the rack profile 21 (into a different seat of said rack profile).

As can be seen by comparing FIGS. 5a e 5b, owing to the fact that the control slider 23 performs a simple translational movement in the transverse direction Y and that the engaging tooth is directly and rigidly connected to the body of said control slider, the kinematic chain is compact and consists of a very small number of components, and adjustment of the position of the headrest along the second direction or longitudinal direction Y is simple and reliable.

In the light of the above, the operation of the headrest 1 according to the invention will be entirely evident to the person skilled in the art.

Starting from an initial configuration, the user can act onto the control button 27 and, by overcoming the elastic resistance of the springs 25, cause a translation of the control slider 23 as well as of the locking elements 13a, 13b and of the engaging tooth 19, which are directly and rigidly connected to the body of said control slider, in the transverse direction Y.

By virtue of this translational movement, the locking elements 13a, 13b will move away from the surface of the respective supporting rods 3a, 3b, thus switching from the locking position to the unlocking position; at the same time, the engagement tooth 19 will move away from the rack profile 21, thus switching from the engagement position to the disengagement position.

At this point, as long as the user holds down the control button 27, the headrest configuration can be changed and adjusted in the vertical direction Z as well as in the longitudinal direction X, adapting it to the needs of the single user occupying the seat.

Once the control button 27 is released, the control slider will be brought back by the action of the springs 25, thereby bringing the locking elements 13a, 13b back to the locking position and, at the same time, bringing the engagement tooth 19 to its position of engagement with the rack profile 21.

The adjustment of the headrest 1 is therefore extremely simple and reliable, and it is based on a very small number of components.

It is evident that the detailed description provided herein of a preferred embodiment should not be taken in a limiting sense and that several variants and modification within the reach of the person skilled in the art can be implemented without thereby departing from the scope of protection defined by the following claims.

For example, it would be possible to provide for the control button (or other control element) to be switchable between two positions, a first position in which it keeps the control slider in the inactive position, and a second position in which it keeps the control slider in the active position. In this way, once the control button is brought to the second position, one should not continue to keep it pressed down while it is adjusting the headrest configuration, but they could release it, the headrest adjustment being continuable until the control button is switched to the first position.

1: A headrest, comprising one or more supporting rods and a headrest body mounted on the supporting rods,
wherein the headrest body comprises an inner frame provided with one or more channels inside which the one or more support rods are respectively housed, and further comprises a front shell and a rear shell,
wherein said inner frame is mounted on the one or more supporting rods in a slidable manner,
wherein the headrest is provided with one or more locking elements, one for each of the one or more supporting rods,
wherein the one or more locking elements are controllable for switching from a locking position, in which the one or more locking elements prevent the inner frame from sliding relative to the one or more supporting rods, to an unlocking position, in which the one or more locking elements allow the inner frame to slide relative to the one or more supporting rods, and vice versa,
wherein the front shell is movable relative to the rear shell,
wherein the headrest is provided with first engaging elements and second engaging elements, which are controllable for switching from an engagement position, in which the first engaging elements and the second engaging elements prevent the front shell from moving relative to the rear shell, to a disengagement position, in which the first engaging elements and the second engaging elements allow the front shell to move relative to the rear shell,
wherein the headrest is provided with a single control slider which controls the one or more locking elements to bring the one or more locking elements from the locking position to the unlocking position and simultaneously controls the first engaging elements or the second engaging elements or both the first engaging elements and the second engaging elements to bring the first and second engaging elements from the engagement position to the disengagement position, and vice versa,
wherein the control slider has a body and the one or more locking elements are directly and rigidly connected to the body of the control slider and the first engaging elements or the second engaging elements or both the first engaging elements and the second engaging elements are directly and rigidly connected to the body of the control slider.

2: The headrest according to claim 1, wherein the control slider is switchable from an inactive position, in which the one or more locking elements are in the locking position and the first and second engaging elements are in the engagement position, to an active position, in which the one or more locking elements are in the unlocking position and the first and second engaging elements are in the disengagement position, and vice versa, and wherein the headrest is provided with a control element for bringing the control slider from the inactive position to the active position.

3: The headrest according to claim 2, wherein the control slider is urged towards the inactive position by means of an elastic elements, and wherein the control element brings the control slider from the inactive position to the active position by overcoming the resistance of the elastic element.

4: The headrest according to claim 2, wherein the inner frame is mounted on the one or more supporting rods so as to be slidable along a first direction and wherein the front shell is movable relative to the rear shell along a second direction, which is perpendicular to the first direction.

5: The headrest according to claim 4, wherein the control slider switches from the inactive position to the active position, and vice versa, by translating along a third direction, which is perpendicular to both the first direction and said the second direction.

6: The headrest according to claim 1, wherein the one or more locking elements are made as one or more shaped wire elements, and wherein one or more notches suitable for accommodating the one or more locking elements are provided on the surface of each of the one or more supporting rods.

7: The headrest according to claim 1, wherein the second engaging elements are made as a rack profile provided with a plurality of seats and the first engaging elements are made as an engaging tooth, suitable for fitting into one of the seats of the rack profile.

8: The headrest according to claim 7, wherein the engaging tooth is directly and rigidly connected to the body of the control slider.

9: The headrest according to claim 1, wherein the front shell is fixedly connected to the inner frame, while the rear shell is connected to a slide, wherein the slide comprises a body which is slidably received in a corresponding seat provided in the inner frame, wherein the first engaging elements are arranged on the inner frame and the second engaging elements are arranged on the slide, and wherein sliding of the slide relative to the inner frame is prevented when the first and said second engaging elements are in the engagement position, while sliding of the slide relative to the inner frame is allowed when the first and said second engaging elements are in the disengagement position.

10: The headrest according to claim 9, wherein the body of the slide is provided with one or more guiding ribs and the seat of the inner frame is provided with one or more guiding grooves, and wherein the one or more guiding ribs cooperate with respective one or more guiding grooves.

11: The headrest according to claim 9, wherein the body of the slide is provided with one or more guiding grooves and the seat of the inner frame is provided with one or more guiding ribs, and wherein the one or more guiding ribs cooperate with respective one or more guiding grooves.

12: The headrest according to claim 1, wherein the rear shell is fixedly connected to the inner frame, while the front shell is connected to a slide, wherein the slide comprises a body which is slidably received in a corresponding seat provided in the inner frame, wherein the first engaging elements are arranged on the inner frame and the second engaging elements are arranged on the slide, and wherein sliding of the slide relative to the inner frame is prevented when the first and said second engaging elements are in the engagement position, while sliding of the slide relative to the inner frame is allowed when the first and said second engaging elements are in the disengagement position.

13: The headrest according to claim 12, wherein the body of the slide is provided with one or more guiding ribs and the seat of the inner frame is provided with one or more guiding grooves, and wherein the one or more guiding ribs cooperate with respective one or more guiding grooves.

14: The headrest according to claim 12, wherein the body of the slide is provided with one or more guiding grooves and the seat of the inner frame is provided with one or more guiding ribs, and wherein the one or more guiding ribs cooperate with respective one or more guiding grooves.

15: The headrest according to claim 1, wherein the inner frame is mounted on the one or more supporting rods so as to be slidable along a first direction, and wherein the front shell is movable relative to the rear shell along a second direction, which is perpendicular to the first direction.
